(19) United States
(12) Patent Application Publication
(10) Pub. No.: US 2012/0072753 A1
(43) Pub. Date: Mar. 22, 2012

(54) ELECTRONIC SYSTEM WITH ROUTER AND CHARGER FUNCTIONS, AND METHOD FOR OPERATING THE SAME

(75) Inventor: UN PIO LEONG, TAIPEI CITY (TW)

(73) Assignee: BANDRICH, INC., TAIPEI COUNTY (TW)

(21) Appl. No.: 12/885,979

(22) Filed: Sep. 20, 2010

(51) Int. Cl. G06F 1/26; G06F 11/30

(52) U.S. Cl. 713/340; 713/300

(57) ABSTRACT

An electronic system with router and charger functions and a method for operating router and charger functions are disclosed. The electronic system connects to an electronic device and includes a router module, a charger module, and a connection interface. In which, the router module has a processing unit and a communication unit, and the charger module has a rechargeable battery. The processing unit and the communication unit may provide data routing capabilities so that the connected electronic device can share the Internet resources to other devices. At the same time, the rechargeable battery of the electronic system may provide electric power to the electronic device for charging the battery within.

### BACKGROUND OF THE INVENTION

1. Field of the Invention

The present invention relates to an electronic system, especially an electronic system with router and charger functions and a method for operating the router and charger functions.

2. Description of Related Art

Because of the progress of technology, people tend to use more and more electronic devices for convenience and satisfaction. Although the sizes of the electronic devices are decreasing, it is still inconvenient to carry or use too many electronic devices.

A router is a device for interconnecting at least two electronic devices or two or more networks. Signals and data transmitted between the devices or networks have addresses so that the router can route the signals and data from a source to a destination. Due to communication requirements, people may carry a router for sharing the Internet resources of an electronic device. Along with the electronic device, an electric power charger may also be involved for charging the electronic device, so that the electronic device can work normally.

However, it is quite inconvenient to bring too many accessories, such as a charger and a router, along with the electronic device. Therefore, it is to say that the described problems should be solved for increasing the practical value of the electronic device.

### SUMMARY OF THE INVENTION

Because of the aforementioned problems, the present invention provides an electronic system with router and charger functions. By integrating router and charger functions in one electronic system, users may not carry too many stuff with the electronic device. Thus, practical value and convenience of using the electronic device can be improved.

For achieving the mentioned purposes, an electronic system with router and charger functions is provided according to the present invention. The electronic system connects to an electronic device for providing the charger and router functions. The electronic system includes a router module, a connection interface, and a charger module. In which the router module has a processing unit and a communication unit, and the charger module has a rechargeable battery.

The processing unit may be a CPU, for processing and routing signals and data. The connection interface may be a universal serial bus (USB) interface which is electrically connected to the processing unit, for connecting the electronic device. The communication unit may include a Wi-Fi communication module which is electrically connected to the processing unit, so that the electronic device may communicate with other devices or share Internet resources through the communication unit. The rechargeable battery is electrically connected to the processing unit, for charging the electronic device by wiring a power source.

Additionally, the electronic system may further include a controller which is electrically connected to the processing unit, the rechargeable battery, and the connection interface. The controller is for controlling whether to transmit electric power stored in the rechargeable battery to the electronic device or not, and for controlling whether to transmit signals and data between the electronic device and the communication unit or not.

The controller may be implemented as a power management integrated circuit (PMIC) for determining whether or not to transmit electric power from the rechargeable battery to the electronic device, and also for controlling signal and data transmissions. Alternatively, the controller may connect to at least one switch unit or button which can be operated by users for switching the router function or the charger function of the electronic system. Furthermore, the electronic system may include a storage unit, such as a flash memory or a secure digital card, for storing data.

According to another scheme of the present invention, a method for operating the router and charger functions of the electronic system is disclosed. When an electronic device is connected to the electronic system, the method then goes to a step of determining whether or not the router function and the charger function are enabled. The method further includes a step of routing signals and data associated with the electronic device if the router function of the electronic system is enabled. Simultaneously, the electronic system may transmit electric power stored in the rechargeable battery to the electronic device if the charger function of the electronic system is enabled.

Additionally, the method may further include one more step of determining whether the electronic system is connected with a power source or not. If the electronic system is connected with the power source, then the electronic system may determine whether the rechargeable battery of the electronic system is fully charged or not, and charges the rechargeable battery of the electronic system if the rechargeable battery is not fully charged.

By providing an electronic system with router and charger functions, the convenience of using the electronic device may be improved.

For further understanding of the invention, reference is made to the following detailed description illustrating the embodiments and examples of the invention. The description is only for illustrating the invention, not for limiting the scope of the claim.

### BRIEF DESCRIPTION OF THE DRAWINGS

The drawings included herein provide further understanding of the invention. A brief introduction of the drawings is as follows:

FIG. 1 is a block diagram of the electronic system according to one embodiment of the present invention;

FIG. 2 is a block diagram of the electronic system according to another embodiment of the present invention;

FIG. 3 is a schematic diagram when using the electronic system as a router according to an embodiment of the present invention;

FIG. 4 is a schematic diagram when using the electronic system as a charger according to an embodiment of the present invention;

FIG. 5 is a flow chart of the method for operating the router and charger functions in the electronic system according to an embodiment of the present invention; and

FIG. 6 is a flow chart of the method for operating the router and charger functions in the electronic system according to another embodiment of the present invention.

### DETAILED DESCRIPTION OF THE PREFERRED EMBODIMENTS

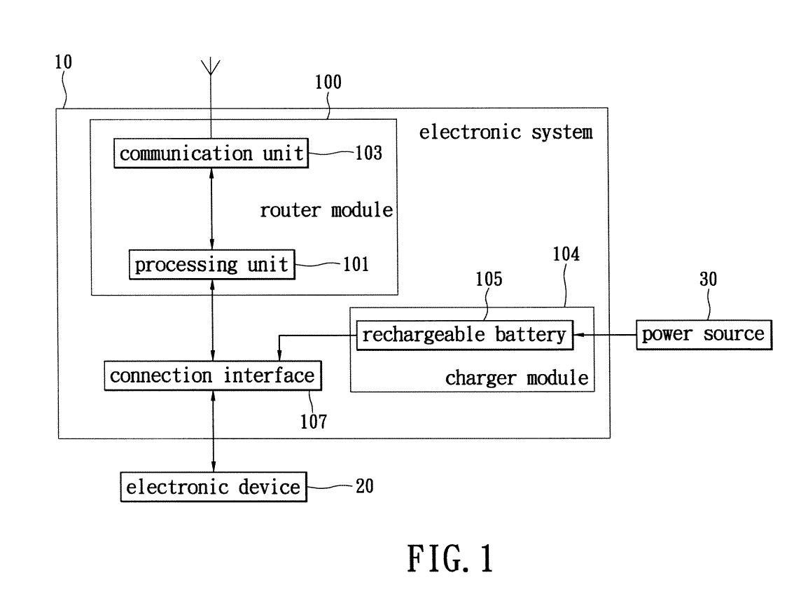

Please refer to FIG. 1, which is a block diagram of an electronic system 10 with router and charger functions according to one embodiment of the present invention. The electronic system 10 has a router module 100, a charger module 104, and a connection interface 107. In which, the router module 100 includes a processing unit 101 and a communication unit 103, and the charger module 104 includes a rechargeable battery 105. The electronic system 10 is connected with an electronic device 20 through the connection interface 107, so that the electronic device 20 may share the Internet resources. Alternatively, the electronic device 20 may simply exchange data with another device through the communication unit 103 without linking to the Internet.

The processing unit 101 of the electronic system 10 is electrically connected to the communication unit 103 and the connection interface 107, for processing and routing signals and data which are transmitted to or from the electronic device 20. The processing unit 101 may be a router processor including a routing table which builds up the preferred paths between any two systems of the interconnected networks. The processing unit 101 routes the transmitted data and signals according to some routing protocols such as RIP, IGRP, EIGRP, OSPF, IS-IS, and BGP, etc.

The communication unit 103 is electrically connected to the processing unit 101, for transceiving data associating with the electronic device 20. The communication unit 103 may have a Wi-Fi communication module for transmitting data and signals between the electronic device 20 and other devices which are linked to the electronic system 10 or for sharing Internet resources. When a router function of the electronic system 10 is enabled, the electronic device 20 which is connected to the electronic system 10 through the connection interface 107 may exchange data and signals with other devices through the operations processed by the processing unit 101 and the communication unit 103. Moreover, the communication unit 103 may include a 3G communication module, for providing mobile communication capability to the electronic device 20, such as a mobile phone.

The rechargeable battery 105 is electrically connected to the connection interface 107, for storing electric power and providing the stored power to the electronic device 20. The rechargeable battery 105 may connect to an external power source 30 for retrieving electric power. Alternatively, the electronic system 10 may have an embedded power source, such as a photovoltaic panel, for providing electric power to the rechargeable battery 105. The electric power stored in the rechargeable battery 105 may also be provided to the processing unit 101 and the communication unit 103.

Additionally, a regulator (not shown) may be electrically connected between the connection interface 107 and the rechargeable battery 105, for adjusting the voltage level of the electric power provided to the electronic device 20. Accordingly, the electronic system 10 may work as a charger of the electronic device 20 when the charger function of the electronic system 10 is enabled.

The connection interface 107 of the electronic system 10 is electrically connected to the rechargeable battery 105 and the processing unit 101, for connecting to the electronic device 20. The connection interface 107 may be a universal serial bus (USB) interface or other types of connection interface.

In this embodiment, the electronic system 10 may serve as a charger and/or a router of the electronic device 20. When the router function and the charger function of the electronic system 10 are enabled, the electronic device 20 can receive electric power from the electronic system 10 while sharing the Internet resources or communicate with other devices through the electronic system 10. Thus, the convenience of using the electronic device 20 may be improved.

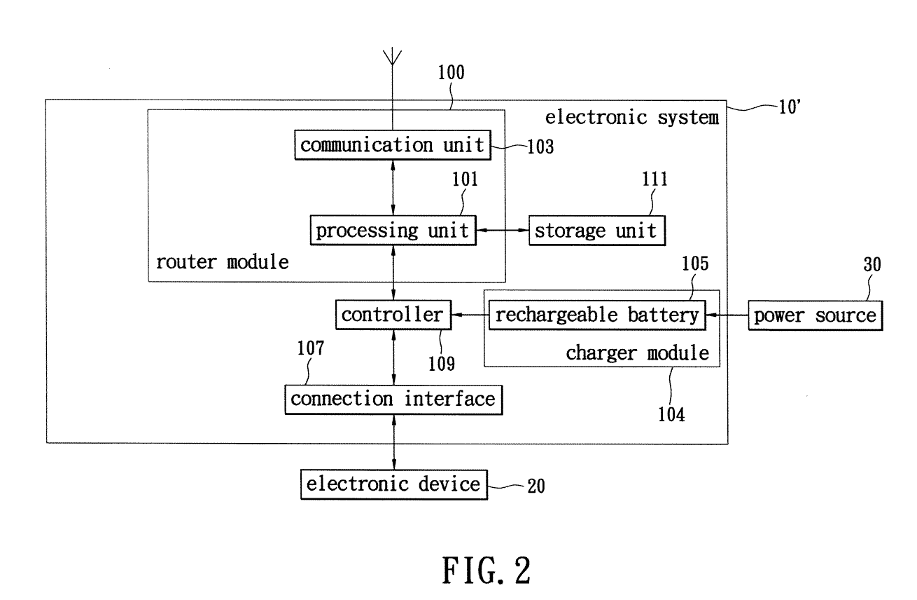

Please refer to FIG. 2, which is a block diagram of an electronic system 10′ with router and charger functions according to another embodiment of the present invention. In this embodiment, the electronic system 10′ has a router module 100, a charger function 104, a connection interface 107, and a controller 109. In which, the router module 100 has a processing unit 101 and a communication unit 103, and the charger module 104 has a rechargeable battery 105.

The differences between FIGS. 1 and 2 are that the electronic system 10′ has the controller 109 which is electrically connected to the processing unit 101, the rechargeable battery 105, and the connection interface 107. The controller 109 is for determining whether to enable the charger and/or the router functions of the electronic system 10′ or not.

The controller 109 of the electronic system 10′ may be implemented as a power management integrated circuit (PMIC), for selectively controlling whether to transmit the electric power from the rechargeable battery 105 to the electronic device 20. Further, the power management integrated circuit may also control whether to transmitting signals and data to or from the electronic device 20.

The controller 109 may include at least one switch which can be operated by users. As an embodiment, the controller 109 includes two switches, one for enabling or disabling the router function of the electronic system 10′, and the other one for enabling or disabling the charger function of the electronic system 10′. As another embodiment, the controller 109 may include a three-status switch stands for three modes of the electronic system 10′. The modes of the electronic system 10′ includes a router mode, a charger mode, and an integrating mode which enables both charger function and router function of the electronic system 10′. Alternatively, the controller 109 may include at least one button which can be operated by users. Users can select the modes of the electronic system 10′ by pressing the buttons of the electronic system 10′. Additionally, the electronic system 10′ may further have a storage unit 111, such as a flash memory or a secure digital (SD) card, for providing extra memory to the electronic device 20. The storage unit 111 is electrically connected to the processing unit 101 for storing data.

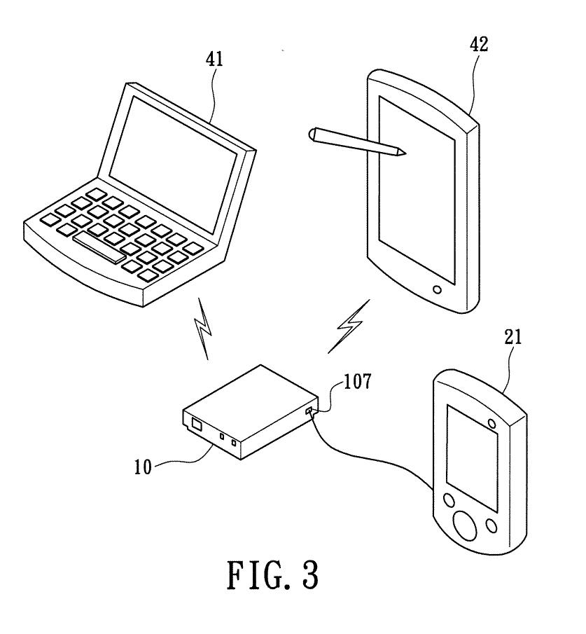

Please refer to FIG. 3, which is a schematic diagram when using the electronic system 10 as a router of the electronic device according to one embodiment of the present invention. In this embodiment, the electronic device is a mobile phone 21. The mobile phone 21 is connected to the electronic system 10 through connection interface 107 which may be a USB port. When the router function of the electronic system 10 is enabled, the mobile phone 21 can share the Internet resources, or simply communicate with other devices (such as a notebook computer 41 or a PDA 42) through the electronic system 10 without Internet linking. At the same time, the electronic system 10 may also provide requisite electric power to the mobile phone 21 through the connection interface 107, so that the battery of the mobile phone 21 can be charged while connecting with the electronic system 10.

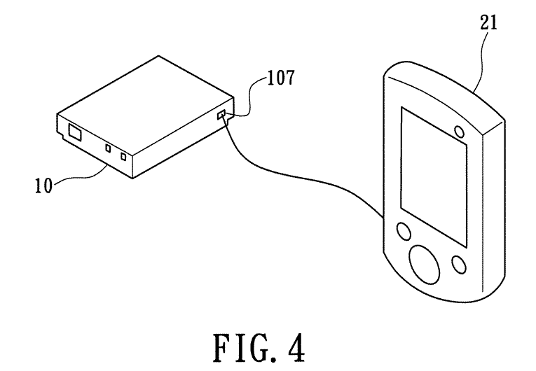

Please refer to FIG. 4, which is a schematic diagram when using the electronic system 10 as a charger of the mobile phone 21 according to one embodiment of the present invention. In this embodiment, the electronic system 10 is simply used as a charger of the mobile phone 21, for providing requisite electric power.

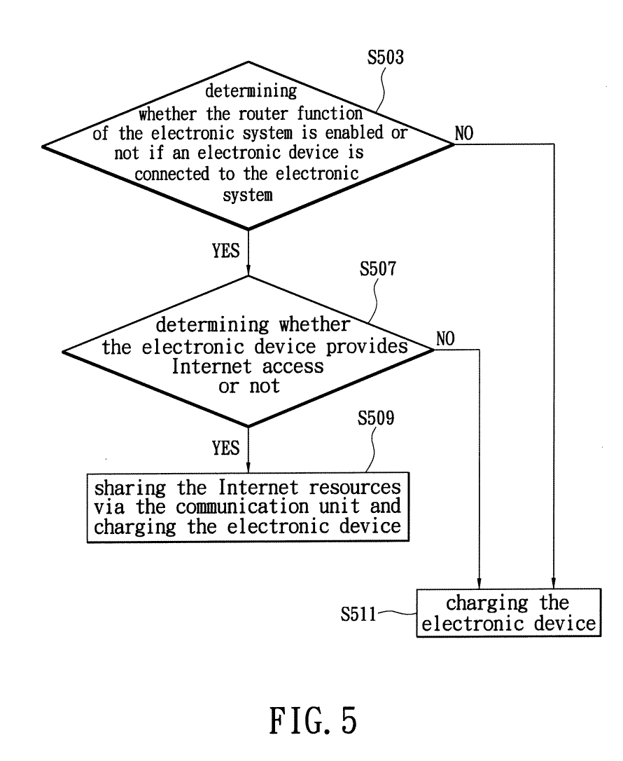

Please refer to FIG. 5, which is a flow chart of the method for operating router and charger functions in the electronic system 10 according to one embodiment of the present invention. The method includes a step of determining whether the router function is enabled or not if an electronic device 20 is connected to the electronic system 10 (S503). In which the router function of the electronic system 10 may be determined and controlled by a controller 109, such as a power management integrated circuit. The controller 109 may have at least one switch or button as described above.

Worth mentioning, the electronic system 10 may detect the electronic device 20 by hardware operations. That is, immediately when the electronic device 20 is connected to the electronic system 10, there may have currents flowing through a detection circuit of the electronic device 20, so the electronic system can detect the connection of the electronic device 20 accordingly. Or, the electronic system 10 may repeatedly detect the connection of the electronic device 20 by software operations. However, the above schemes are just some embodiments for detecting the electronic device 20, and are not for limiting the scope of the present invention.

Please refer to FIG. 5 again, even if the router function is not enabled, the electronic system 10 may still provide the electric power stored in the rechargeable battery 105 to the electronic device 20 (S511), for charging the battery of the electronic device 20. That is, when the router function is not enabled, the electronic system 10 works simply as a charger of the electronic device 20.

If the router function is enabled, the electronic system 10 then determines whether the electronic device 20 provides Internet access or not (S507). If the electronic device 20 does not provide Internet access, then the method goes to step S511 for charging the electronic device 20. On the other hand, if the electronic device 20 does provide Internet access, the electronic system 10 then shares the internet resources to the electronic device 20 via the communication unit 103 of the electronic system 10, and also provides electric power to the electronic device 20 for charging it (S509). In addition, even if the Internet access is not provided, the electronic device 20 may still communicate with another device through the electronic system 10 without connecting to the Internet.

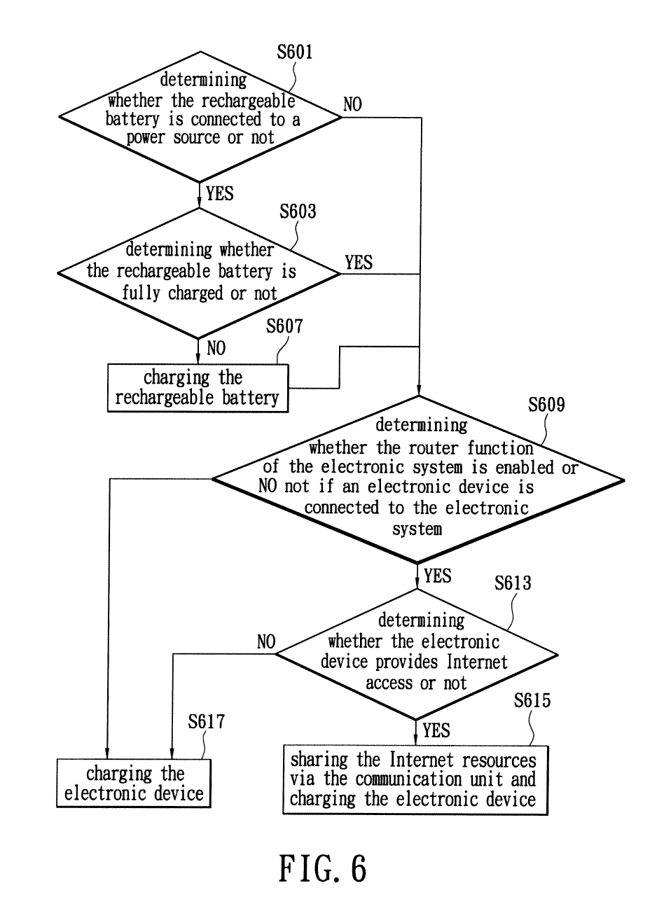

Please refer to FIG. 6, which is a flow chart of the method for operating router and charger functions of the electronic system 10 according to one embodiment of the present invention. The method includes a step of determining whether the rechargeable battery 105 is connected to a power source or not (S601). Alternatively, the power source may be a module which is embedded in the electronic system 10, so that the step S601 may not be executed.

If the rechargeable battery 105 does connect to the power source, then the electronic system 10 determines whether the rechargeable battery 105 is fully charged or not (S603). If the rechargeable battery 105 is not fully charged, the electronic system 10 would then charge the rechargeable battery 105 (S607). If the rechargeable battery 105 does not connect to the power source, or if the rechargeable battery 105 is fully charged, the method then goes to the step of determining whether the router function is enabled or not when an electronic device 20 is connected to the electronic system 10 (S609).

If the router function is not enabled, the electronic system 10 may simply provide the electric power stored in the rechargeable battery 105 to the electronic device 20 (S617), for charging the electronic device 20. On the other hand, if the router function is enabled, the electronic system 10 then determines whether the electronic device 20 provides Internet access or not (S613). If the electronic device 20 does not provide Internet access, then the method goes to step S617 for simply charging the electronic device 20. Otherwise, if the electronic device 20 does provide Internet access, the electronic system 10 would share the Internet resources to the electronic device 20 via the communication unit 103 of the electronic system 10, and also provides electric power to the electronic device 20 for charging it (S615).

It is worth mentioning that even when the electronic device 20 does not provide Internet access, it still can communicate with other devices through the electronic system 10 without connecting to the Internet.

Therefore, by integrating the router function and the charger function in one electronic system, user may not need to use too many accessories with one electronic device. According to the present invention, the practical value and convenience of using the electronic device are improved.

Some modifications of these examples, as well as other possibilities will, on reading or having read this description, or having comprehended these examples, will occur to those skilled in the art. Such modifications and variations are comprehended within this invention as described here and claimed below. The description above illustrates only a relative few specific embodiments and examples of the invention. The invention, indeed, does include various modifications and variations made to the structures and operations described herein, which still fall within the scope of the invention as defined in the following claims.

What is claimed is:

1. An electronic system with router and charger functions, comprising:
a connection interface for connecting an electronic device;
a router module electrically connected to the connection interface for providing the router function, the router module including:
a processing unit electrically connected to the connection interface for processing and routing signals and data;
a communication unit electrically connected to the processing unit, for transceiving signals and data; and
a charger module electrically connected to the connection interface for providing the charger function, the charger module including:
a rechargeable battery electrically connected to the connection interface, for receiving and storing electric power from a power source, and for providing electric power to the electronic device.

2. The electronic system as in claim 1, further comprising:
a controller electrically connected to the processing unit, the rechargeable battery, and the connection interface, for controlling whether to transmit electric power stored in the rechargeable battery to the electronic device or not, and for controlling whether to transmit signals and data between the electronic device and the communication unit or not.

3. The electronic system as in claim 2, wherein the controller is a power management integrated circuit.

4. The electronic system as in claim 2, wherein the controller connects to at least one switch unit which can be operated by users for enabling or disabling the router function of the electronic system, and for enabling or disabling the charger function of the electronic system.

5. The electronic system as in claim 2, wherein the controller connects to at least one button which can be operate by users for enabling or disabling the charger function of the electronic system, and for enabling or disabling the router function of the electronic system.

6. The electronic system as in claim 1, wherein the communication unit includes a Wi-Fi communication module.

7. The electronic system as in claim 1, wherein the communication unit includes a 3G communication module.

8. The electronic system as in claim 1, further comprising:
a storage unit electrically connected to the processing unit, for storing signals and data.

9. The electronic system as in claim 8, wherein the storage unit is a secure digital (SD) card, or a flash memory.

10. The electronic system as in claim 1, wherein the electronic device is a mobile phone.

11. The electronic system as in claim 1, wherein the connection interface is a universal serial bus (USB) interface.

12. A method for operating router and charger functions of an electronic system, in which the electronic system has a connection interface, a communication unit, and a rechargeable battery, the method comprising:
routing signals and data associated with the electronic device if a router function of the electronic system is enabled if an electronic device is connected to the electronic system via the connection interface; and
transmitting electric power stored in the rechargeable battery to the electronic device if the charger function of the electronic system is enabled.

13. The method as in claim 12, further comprising:
detecting whether or not the electronic device is connected to the connection interface of the electronic system via the connection interface.

14. The method as in claim 12, further comprising:
determining whether the electronic system is connected with a power source or not;
determining whether the rechargeable battery of the electronic system is fully charged or not if the electronic system is connected with the power source; and
charging the rechargeable battery of the electronic system if the rechargeable battery is not fully charged.

15. The method as in claim 12, further comprising:
determining whether the router function of the electronic system is enabled or not before routes signals and data associated with the electronic device.

16. The method as in claim 12, further comprising:
determining whether the charger function of the electronic system is enabled or not before transmits electric power stored in the rechargeable battery to the electronic device.

17. The method as in claim 12, wherein the communication unit includes a Wi-Fi communication module.

18. The method as in claim 12, wherein the communication unit includes a 3G communication module.

19. The method as in claim 12, wherein the connection interface is a universal serial bus (USB) interface.

20. The method as in claim 12, wherein the electronic device is a mobile phone.
